(19) United States
(12) Patent Application Publication
(10) Pub. No.: US 2016/0130443 A1
(43) Pub. Date: May 12, 2016

(54) PHTHALOCYANINE DYE USED FOR COLOR FILTER OF A LCD

(71) Applicant: DOW GLOBAL TECHNOLOGIES LLC, Midland, MI (US)

(72) Inventors: chao He, Shanghai (CN); Yanping Sun, Shanghai (CN); Yang Li, Shanghai (CN); Xiangyang Tai, Shanghai (CN); Guihong Liao, Shanghai (CN); Tianhui Xiao, Shanghai (CN); Nan Hu, Shanghai (CN); Qingshan Jason Niu, Qingdao (CN); Xinyu Cao, Shanghai (CN); Hua Ren, Shanghai (CN); Yu Cai, Shanghai (CN)

(21) Appl. No.: 14/895,227

(22) PCT Filed: Jul. 26, 2013
(86) PCT No.: PCT/CN2013/080216

§ 371 Date: Dec. 2, 2015

(51) Int. Cl. C09B 47/04; G02B 1/04

(52) U.S. Cl. CPC C09B 47/045; G02B 1/04

(57) ABSTRACT

Aphthalocyanine dye which is suitable for forming a color filter used for a liquid crystal display device, a composition containing an alkaline soluble resin and the phthalocyanine dye, an article having a polymer layer containing the dye and an alkaline soluble resin and a color filter containing the dye are developed.

### FIELD OF THE INVENTION

The present invention relates to aphthalocyanine dye which is suitable for forming a color filter used for a liquid crystal display device, a composition containing an alkaline soluble resin and the phthalocyaninedye, an article having a polymer layer comprising the phthalocyanine dye and an alkaline soluble resin and a color filter comprising the dye.

### BACKGROUND OF THE INVENTION

Liquid crystal display (LCD) currently dominates the display market because of its excellent performance and small thickness. As a key component of LCD device, translucent color filters play the critical role of generating Red/Green/Blue lights by filtering white light from a back sheet. This capacity originates from the Red/Green/Blue colorants comprised in color filter units. Each colorant possesses a characteristic absorbance spectrum and will show one of the three primary colors when illuminated with white visible light-wavelength ranges from 380 nm to 780 nm. The controlled mixing of primary colors from each color filter unit produced by colorant will generate the final color of pixels. So the efficiency of color filter determines LCD's performance directly.

Normally, the commercialized colorants used in a LCD color filter are exclusively pigments, because they have good stability against heat, light and chemicals. Unfortunately pigments must be ground into micro/nano particles before added into a color resist to make a color filter due to their intrinsic insolubility property. When the color filter is illuminated, light scattering will take place on these particles with diameter of ˜100 nm. As a result lots of light signals will lose and transmittance will become low, which means more light energy must be applied to provide enough brightness of the LCD.

In contrast to pigments, dyes are soluble in many materials which ensure that they can be dispersed at molecular level. If dyes are used in a color filter instead of pigments, light scattering will be significantly reduced. So it could be imagined that the dye based color filter will have higher transmittance and energy cost will thus be reduced greatly. However, dye's stability against light, heat and chemical resistance is generally inferior to pigments. As a result, at present, the commercialized LCD color filters are almost pigment with limited exceptions for a few of pigment-dye hybrid ones.

Some phthalocyaninedyes are used for color filters of a LCD. Some phthalocyaninedye substituted by sulfur containing groups or halogen-containing groups has been proposed for color filters, see e.g. US2011/0020738A, U.S. Pat. No. 6,533,852, U.S. Pat. No. 7,473,777 and U.S. Pat. No. 6,826,001, but those dyes generally have insufficient thermal stability or insoluble common organic solvent for a color filter.

Although the phthalocyanine structure is stable, the low solubility of phthalocyaninedyes in an organic solvent prevents the use of phthalocyaninedyes for a color filter. Accordingly, aphthalocyanine dye which is stable and satisfies the solubility in an organic solvent at the same time is still desired.

### SUMMARY OF THE INVENTION

Inventors of this invention have now found that new type of phthalocyaninedye which is stable and has good solubility in an organic solvent. The phthalocyaninedye is represented by the general formula (1)

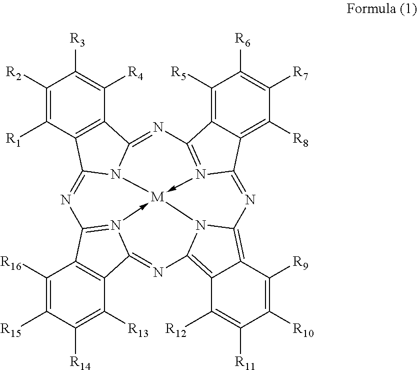

wherein R1 to R16 are independently selected from the group consisting of;
(A)hydrogen atom,
(B)straight-chain, branched or cyclic saturated or unsaturated hydrocarbon group having 1-50 of carbon atoms,
(C)aryl group substituted by at least one saturated or unsaturated hydrocarbon group having 1-50 of carbon atoms,
(D)aryloxy group substituted by at least one saturated or unsaturated hydrocarbon group having 1-50 of carbon atoms and
(E)—O—R17, wherein R17 is saturated or unsaturated hydrocarbon group having 1-50 of carbon atoms.

At least one of R1 to R4, at least one of R5 to R8, at least one of R9 to R12 and at least one of R13 to R16 are selected from the group consisting of (B), (C), (D) and (E).M is selected from Zn²⁺, Cu²⁺, Ni²⁺, AlCl²⁺ or SiCl₂²⁺.

This group of phthalocyanine dyes does not have a sulfur-containing group, so they have excellent thermal stability. In addition, such a phthalocyanine dye has high enough solubility for an organic solvent due to the peripheral organic groups of the phthalocyaninedye, so the phthalocyaninedye of this invention is useful for a color filter used in a LCD.

### DETAILED DESCRIPTION OF THE INVENTION

As used throughout this specification, the abbreviations given below have the following meanings, unless the context clearly indicates otherwise: g=gram; mg=milligram; mm=millimeter; min.=minute(s); s=second(s); hr.=hour(s); rpm=revolution per minute; ° C.=degree Centigrade. Throughout this specification, “(meth)acrylic” is used to indicate that either “acrylic” or “methacrylic” functionality may be present. As used throughout this specification, the word ‘resin’ and ‘polymer’ is used interchangeably. The word ‘alkaline soluble resin’ and ‘binder’ is used interchangeably.

### <Phthalocyaninedye>

The present invention provides a phthalocyaninedye represented by the general formula (1).

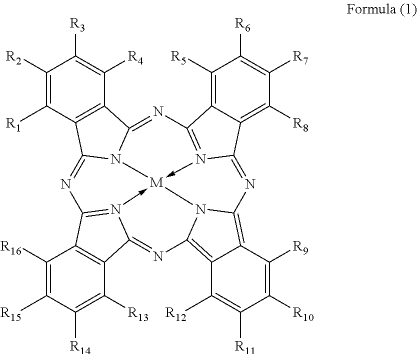

R1 to R16 of the formula (1) are independently selected from the group consisting of the following (A) to (E).
(A)hydrogen atom
(B)straight-chain, branched or cyclic saturated or unsaturated hydrocarbon group
(C)aryl group substituted by at least one saturated or unsaturated hydrocarbon group
(D)aryloxy group substituted by at least one saturated or unsaturated hydrocarbon group
(E)—O—R17, wherein R17 is saturated or unsaturated hydrocarbon group.

The straight-chain, branched or cyclic saturated or unsaturated hydrocarbon group designated as (B) above has at least 1 carbon atom, preferably at least 8 carbon atoms, and has less than 50 carbon atoms, preferably less than 20 carbon atoms. Unsaturated hydrocarbon includes alkene, alkadiene, alkapolyene such as alkatriene and alkatetraene, alkyne, alkadiyne, alkapolyyne such as alkatriyne and alkatetrayne, alkenyne and alkapolyenyne such as alkatrienyne and alkenediyne. Examples of the straight-chain, branched or cyclic saturated hydrocarbon group are; methyl, ethyl, propyl, butyl, hexyl, octyl, decyl, dodecyl, hexadecyl, octadecyl, isopropyl, sec-propyl, sec-butyl, tert-butyl, 2-ethylhexyl, cyclohexyl, 1-norbornyl and 1-adamantyl. Examples of the straight-chain, branched or cyclic unsaturated hydrocarbon groups are; hexa-3-enyl, hexa-2,4-dienyl, hexa-1-ynyl, hexa-1,3-diynyl, hexa-1-en-3-ynyl, pentadeca-8-enyl, pentadeca-8,11-dienyl, pentadeca-8,11,14-tryenyl, pentadeca-8-ynyl and pentadeca-8,11-diynyl.

The saturated or unsaturated hydrocarbon group disclosed in (C), (D) and (E) above has at least 1 carbon atom, preferably at least 8 carbon atoms, and has less than 50 carbon atoms, preferably less than 20 carbon atoms. Unsaturated hydrocarbon is same as the one disclosed above.

In the formula (1), at least one of R1 to R4, at least one of R5 to R8, at least one of R9 to R12 and at least one of R13 to R16 are selected from the group consisting of (B), (C), (D) and (E).

M of the formula (1) is selected from Zn²⁺, Cu²⁺, Ni²⁺, Co²⁺, AlCl²⁺ or SiCl₂²⁺.

One preferable subject of this invention is, at least one of R1 to R4, at least one of R5 to R8, at least one of R9 to R12 and at least one of R13 to R16 in the formula (1)are selected from unsaturated hydrocarbon groups of (B)-(E) above. More preferably, at least one of R1 to R4, at least one of R5 to R8, at least one of R9 to R12 and at least one of R13 to R16 in the formula (1) are selected from unsaturated hydrocarbon group of (D).

In other words, such preferable pattern of the formula (1) has at least four substituents which have unsaturated carbon chains at the each site of R1 to R4, R5 to R8, R9 to R12 and R13 to R16. Those phthalocyaninedyes show high thermal stability when they used for a color filter of a LCD, because the unsaturated bonds in the substituents of the dyes can form cross-linkage with a resin which used for the color filter.

In this specification, ‘unsaturated hydrocarbon group’ means at least 90% of hydrocarbon groups of a dye are unsaturated, preferably 95% of hydrocarbon groups are unsaturated.

More preferably, the four substituents having unsaturated carbon chains of the formula (1) are different each other. In other word, the phtyalocyanine dye which has unsymmetry structure is more preferable. Because such unsymmetry structure prevents intermolecular interaction, so the solubility of the dye in the common organic solvent is highly improved.

Another preferable subject of this invention is, two or more of R1 to R4, two or more of R5 to R8, two or more of R9 to R12 and two or more of R13 to R16 in the formula (1) are selected from the group consisting of (B), (C), (D) and (E) above. Because such composition increases the solubility in the most common organic solvent for making a color filter.

Another preferable subject of this invention is, the phthalocyanine dye of this invention is represented by the general formula (2).

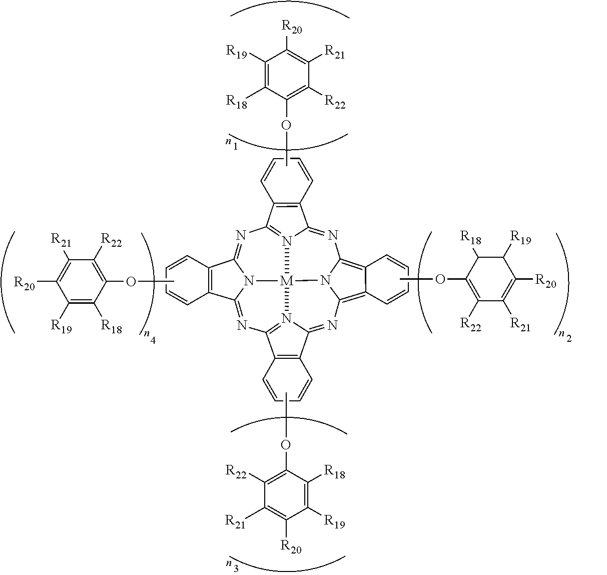

R18 to R22 are independently selected from the group consisting of hydrogen atom and saturated or unsaturated hydrocarbon groups. The carbon atoms of saturated or unsaturated hydrocarbon groups are at least 1, preferably at least 8. At the same time, the carbon atoms of those hydrocarbon groups are 50 or less, preferably 20 or less. At least one of R18 to R22is saturated or unsaturated hydrocarbon group. n1, n2, n3 and n4 are integer of 1 to 4. Mis selected from Zn²⁺, Cu²⁺, Ni²⁺, Co²⁺, AlCl²⁺ or SiCl₂²⁺, preferably M is Zn²⁺.

The phthalocyanine dye of the present invention can be used as a mixture of phthalocyaninedyes which have different substituents.

The phthalocyanine dye of the formula (1) is useful for a color filter of a LCD since the phthalocyanine dye of the invention has excellent thermal stability and high enough solubility for an organic solvent.

The phthalocyanine dye of the present invention can be synthesized by the two steps such as disclosed in Journal of Porphyrines and Phthalocyanines1,7, 52-57 (2003). The first step is a synthesis of a substituted phthalonitrile, and the second step is a synthesis of a phthalocyanine from the phthalonitrile and a metal compound. Therefore, when synthesize a phthalocyanine dye substituted by at least one saturated hydrocarbon groups, the corresponding phthalonitrile should be synthesized in the first step.

When synthesize a phthalocyanine dye substituted by aryloxy groups substituted by at least one unsaturated hydrocarbon group, the following chemical formula (Formula (2)) for synthesis a mixture of phthalocyanine can be used as the first step.

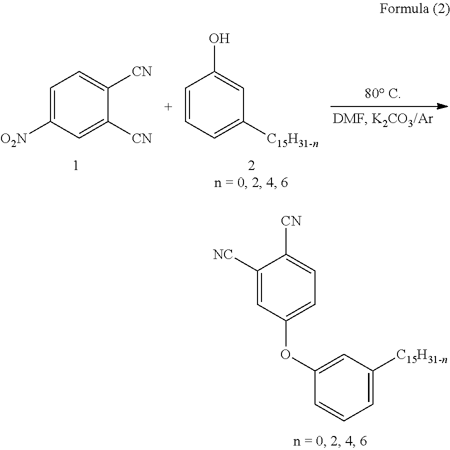

For the second step, the following example for synthesis of the mixture disclosed in the following formula (formula (3)) can be used.

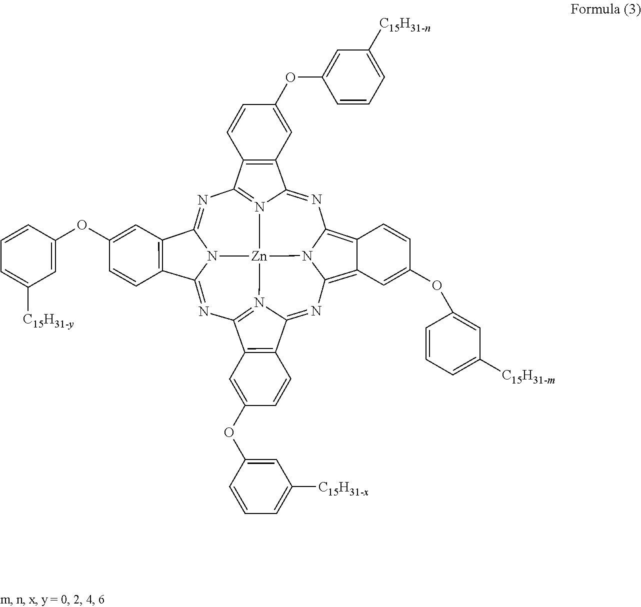

1 g of a mixture of phthalonitrile (2.34 mmol) and 0.1 g of Zn(OAc)₂ (0.58 mmol) in 10 mL of dry 1-hexanol is heated to 100° C., then 1 mL of 1,8-diazabicyclo[5,4,0]undec-7-ene (DBU) is added. The mixture is stirred at 140-150 ° C. for 24 h. then the solvent is removed, the residue is purified on silica gel chromatography to get greenish solid phtyalocyanine mixture. (0.4 g, yield: 38%).

When synthesize a phthalocyanine dye substituted by alkoxy substituted phthalonitrile, the following example for synthesis of 3-propoxyphthalonitrile can be used as the first step.

2.0 g of 1-propanol is dissolved in 6 mL of dried DMSO under N₂atmosphere and 1.53 g of 3-nitrophthalonitrile is added. After stirring for 10 minutes, 2.55 g of finely ground anhydrous K₂CO₃ is added in portion over 2 h with efficient stirring. The reaction mixture is stirred under an argon atmosphere at room temperature for 24 hours, and then the solvent is evaporated under reduced pressure. 5 mL of water is added and the aqueous phase is extracted three times with 10 mL of CH₂Cl₂. The combined extracts are treated first with 5% of Na₂CO₃ solution, then with water and dried with anhydrous Na₂SO₄. CH₂Cl₂ is removed under reduced procedure. 3-propoxyphthalonitrileproduct is obtained.

When synthesize a phthalocyanine dye substituted by saturated straight-chain hydrocarbon groups, the following example for synthesis of 4,5-bis(hexyl)phthalonitrile can be used as the first step.

1.25 g of triphenylphosphine, 1.56 g of [NiCl₂(PPh₃)₂] and 3 g of LiClare stirred in 50 mL of dry THF under N₂ atmosphere. A solution of 2.5 M of nBuLi in 2 mL of hexane is added in the above THF solution using a syringe. 5 g of 4,5-dichlorophthalonitrile is added and the solution is left to stir for a few minutes. Then it is cooled down to −78° C. A solution of 0.5 M of hexylzincbromide in 100 mL of THF is added dropwise to the above cooled solution. The mixture is left to warm to room temperature and is stirred overnight. The solution is poured into 100 mL of 5% aqueous HCl and extracted twice with 50 mL of ethyl acetate. It is further washed with 30 mL of 5% HCl aqueous solution, 30 mL of 5% NaOH aqueous solution, and 30 mL of brine, then dried by MgSO₄ and filtered. The solvents are then removed under reduced pressure. 4,5-Bis(hexyl)phthalonitrile product is obtained.

### <Composition>

The composition of the present invention comprises at least one compound as recited in formula (1) and an alkaline soluble resin. The composition preferably additionally comprises a cross-linker (cross-linking agent), a solvent and a radiation-sensitive compound such as a photo initiator. The composition can form a film useful for a color filter.

The content of the dyeas recited in formula (1) in the composition of the present invention varies depending on each molar absorption coefficient and required spectral characteristics, film thickness, or the like, but it is preferably at least 1 wt %, more preferably at least 2 wt % based on the total solid contents of the composition. The preferable content is less than 80 wt %, more preferably less than 70 wt %, most preferably less than 50 wt % based on the total solid contents of the composition.

The composition of the present invention can comprises other coloring materials in addition to the dyeas recited in formula (1). Normally the use of additional coloring material is determined from the required spectral characteristics of a material to be formed from the composition.

The alkaline soluble resin is also known as ‘binder’ in this technical art. Preferably, the alkaline soluble resin is dissolved in an organic solvent. The alkaline soluble resin can be developed with an alkaline solution such as tetramethyl ammonium hydroxide aqueous solution (TMAH) after forming a film.

The alkaline soluble resin (binder) is normally a linear organic polymer. The binder optionally has a crosslinkable group within the polymer structure. When the composition of the present invention is used as a negative type photosensitive composition, such crosslinkable group can react and form crosslink by exposure or heating so that the binder becomes a polymer which is insoluble in alkaline.

Many kinds of binder are known in this art. Examples of such binder are; (meth)acrylic resin, acrylamide resin, styrenic resin, polyepoxyde, polysiloxane resin, phenolic resin, novolak resin, and co-polymer or mixture of those resins. In this application, (meth)acrylic resin (polymer) includes copolymer of (meth)acrylic acid or ester thereof and one or more of other polymerizable monomers. For example, acrylic resin can be polymerized from acrylic acid and/or acrylic ester and any other polymerizable monomers such as styrene, substituted styrene, maleic acid or glycidyl (meth)acrylate.

The binder preferably has at least 1,000 of weight-average molecular weight (Mw), more preferably at least 2,000 of Mw measured by a GPC method using polystyrene as a standard. At the same time, the binder preferably has less than 200,000 of Mw, more preferably less than 100,000 of Mw measured by the same method described above.

The amount of the binder used in the composition of the present invention is preferably at least 10 wt %, more preferably at least 20 wt % based on the total solid contents of the composition. At the same time, the preferable amount of the binder is less than 90 wt %, more preferably less than 80 wt % based on the total solid contents of the composition.

The composition of this invention optionally further comprises a cross-linking agent to obtain a further hardened material. When the composition of this invention is used as a negative type photosensitive composition, such cross-linking agent can form a crosslink by exposure or heating and contribute to get a further hardened material. Well known cross-linking agent can be used for the composition of this invention. Examples of cross-linking agents are epoxy resin and substituted nitrogen containing compound such as melamine, urea, guanamine or glycol uril.

The composition of this invention optionally further comprises a solvent. The solvent to be used for the composition is not limited, but preferably selected from the solubility of components of the composition such as alkaline soluble resin or phthalocyanine dye. Examples of the preferable solvent include esters such as ethylacetate, n-butyl acetate, amyl formate, butyl propionate or 3-ethoxypropionate, ethers such as diethylene glycol dimethyl ether, ethylene glycol monomethyl ether or propylene glycol ethyl ether acetate and ketones such as methylethylketone, cyclohexanone or 2-heptanone.

When the composition of this invention is a negative type radiation-sensitive composition, the composition preferably comprises a photo initiator. Photo initiator also called as photopolymerization initiator and including radical initiator, cationic initiator and anionic initiator. Examples of a photo initiator include; oximeesther type initiator, sulfonium salts initiator, iodide salts initiator and sulfonate initiator.

The composition of this invention can comprise other radiation-sensitive compound such as a radiation sensitive resin or a photo acid generator.

### <Polymer Layer>

The composition of the present invention described above can form a polymer layer on an article. The polymer layer also described as ‘polymer film’ in the specification.

The contents of the compound as recited in formula (1) in the polymer layer is depend on the required color of the film, but at least 1 wt %, preferably at least 10 wt % based on the polymer layer. At the same time, the content is less than 50 wt %, preferably less than 30 wt % based on the polymer layer. The polymer layer also comprises an alkaline soluble resin which is disclosed above.

The polymer layer optionally comprises a photo initiator, a photo acid generator, a radiation sensitive resin and a crosslink agent disclosed above.

The method of forming the polymer layer on an article comprises the steps of; mixing the compound as recited in formula (1) with an alkaline soluble resin and solvent, coating the mixture on an article which supports a layer and heating the article to form a polymer layer (film). Optionally, the method comprises one or more of steps of exposing a layer (film) or curing a layer to form crosslinked stable layer.

The alkaline soluble resin and the solvent used to the method for forming the polymer layer are same as the one disclosed avobe.

Examples of an article which supports a layer (film) are glass, metal, silicon substrate and metal oxide coated material.

Any coating method can be used for the coating step, such as rotation coating, cast coating or roll coating.

The thickness of the layer (film) varies depending on the required properties of the film, but the polymer layer comprising the phthalocyaninedye as recited in formula (1) could be thicker than the one comprising other pigments, because of its good solubility in an organic solvent. The thickness of the layer is 0.1 to 4 micron, preferably 0.5 to 3 micron.

The layer (film) has high transmittance and thermal stability from the properties of the phthalocyanine dye of this invention. The phthalocyanine dye can be dissolved in an organic solvent, and has high thermal stability. Therefore the dye does not prevent the transmittance of a film and does not decrease the thermal stability of the film. Such property is important for a color filter of LCD. Therefore, the layer (film) of the present invention is useful as a color filter of LCD.

### <Color Filter>

The color filer of this invention comprises at least one compound as recited in formula (1). The layer (film) disclosed above can be used for the color filter. Normally, a color filter has multiple units which made from colored films comprising Red/Green/Blue colorants.

The contents of the compound as recited in formula (1) in a colored film for a color filter is same as the film disclosed above, at least 1 wt %, more preferably at least 10 wt % based on the total weight of the colored film. At the same time, the content is less than 50 wt %, preferably less than 30 wt % based on the total weight of the colored film.

A film used for a color filter can be formed by the following steps; coating a solution comprising the compound as recited in formula (1), binder, a photo initiator and solvent to form a radiation sensitive composition layer on a material, exposing the layer through a patterned mask, and developing the layer with an alkaline solution. Moreover, a curing step of further heating and /or exposing the layer after developing step may be conducted as needed.

Since a color filter comprises three colored films which comprise R/G/B colorant, the steps of forming each colored film are repeated, then a color filter having such three colored films are obtained.

### EXAMPLES

### Inventive Example 1

Aphthalocyanine dye (Dye 1) disclosed below was used in example 1.

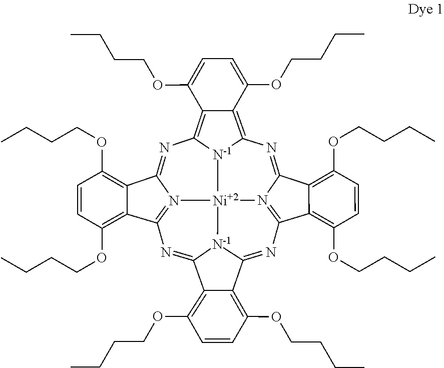

0.05 g of Dye 1 (supplied from Aldrich, 97% purity), 1.6 g of cyclohexanone and 0.7 g of alkaline soluble acrylic resin (MIPHOTO RPR5200, supplied from Miwan Commercial Co., Ltd., 25-35% of solid content in methyl 3-methoxypropionate) were mixed and stirred for 5 minutes at room temperature. Then the solution was spin coated onto a glass plate (thickness: 1 mm, spinning rate: 400 rpm, time: 18 s) using KW-4A type spin coater made by KunshanLidianJingmiJixie Co., Ltd. The wet film was inserted in an oven and heated at 90° C. for 30 min, then at 150° C. for 15 min. Film thickness, transmittance and chromaticity coordinates of the obtained film were measured as disclosed below. Film thickness of the film was 0.9 micron, transmittance of the film was 93.8% based on glass plate coated by acrylic resin only. Chromaticity coordinates measured by UltraScan Pro (Hunterlab) colorimeter was, x=0.3373, y=0.3781 and Y=80.47.

The obtained dry film was baked at 230° C. under air for 1 hour to evaluate thermal stability of the film. Optical performance before and after baking (ΔE_{ab} value) was 1.6. A smaller ΔE_{ab} value indicates better heat resistance. The result is shown in Table 1.

### <Performance Evaluation>

### (1) Thermal Stability of Dyes (Mass Loss Measured by TGA):

The thermal stability of dye itself was determined by the mass loss of dye measured by TGA under air atmosphere at 230° C. for 1 hour. This evaluation reflects chemical stability of the dye itself

### (2) Film Thickness:

Film thickness is measured by scanning the difference in height across the boundary of film and glass substrate with atomic force microscope.

### (3) Chromaticity Coordinates:

The chromaticity coordinate of film on a glass sheet is directly recorded with UltraScan Pro (Hunterlab) colorimeter. The light source is D65.

### (4) Thermal Stability of Films (Chromaticity):

The wet film after spin coating is dried in oven at 90° C. for 30 minutes and then soft baked at 150° C. for 15 minutes. The chromaticity coordinates (L, a, b) are recorded with UltraScan Pro (Hunterlab) colorimeter. D65 light source is used and results are based on CIE Lab coordinates. After that the film is hard baked at target temperature (230° C.) for 1 hour and the new chromaticity coordinates (L′, a′, b′) are recorded with the method above. The thermal stability of a film is indicated by the difference of chromaticity coordinate before and after hard baking represented by the following formula;

ΔE=\sqrt{(L−L′)²+(a−a′)²+(b−b′)²}

### (6) Thermal Stability of Dyes (Chromaticity Difference):

The chromaticity difference of dye without resin was measured to find thermal stability of a dye itself. It reflects the chemical environment interactions between dye molecule themselves, or between dye molecule and a solvent.

A mixture of dye and solvent is spin coated on a glass plate, then dried in oven at 90° C. for 30 minutes and then baked at 230° C. for 1 hour. The chromaticity coordinates (L, a, b) before and after are recorded same as above.

### Inventive Example 2

Same procedure was conducted excepting for Dye 2 (supplied from Aldrich, 97% purity) disclosed below was used instead of Dye 1.

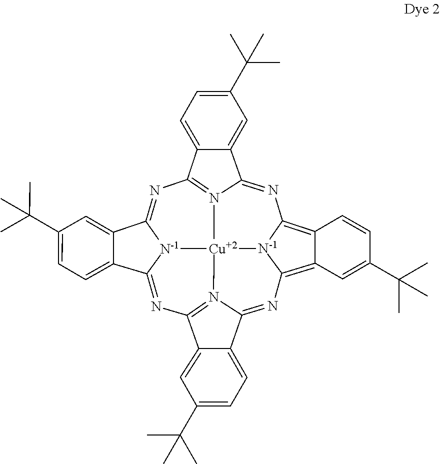

### Inventive Example 3

Same procedure was conducted excepting for Dye 3 mixture disclosed below was used instead of Dye 1.

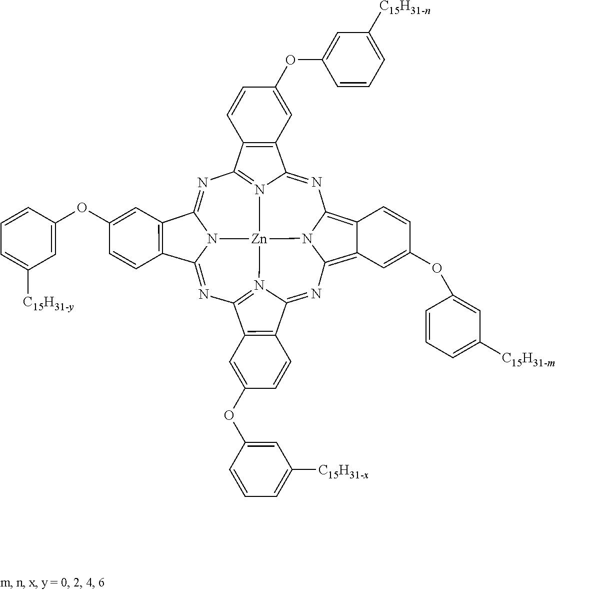

### Dye 3 (Mixture)

### Synthesis of Dye 3 Mixture

a. Synthesis of Phthalonitrile

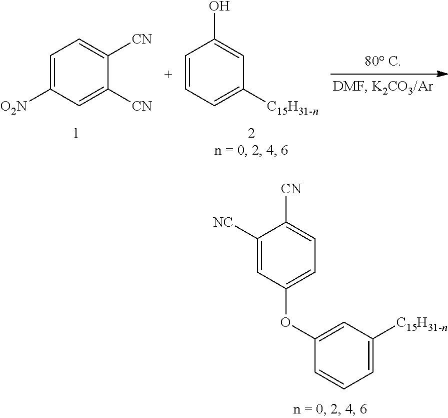

1 g of 4-nitrophthalonitrile (5.77 mmol) and 2.7 g of cardanol (6.3 mmol, supplied from Hua Da Sai Gao Technology Company Limited, n=0(2%), n=2(34%), n−4(22%), n=6(41%)) were dissolved in 30 mL of dry DMF and 1.2 g of anhydrous K₂CO₃ (8.7 mmol) was added in portions during 4 hours. The mixture was stirred at 80° C. for 10 hours under nitrogen atmosphere, then the solvent was removed, the residue was purified on silica gel chromatography to get oily liquid phthalonitrile (2.2 g, yield: 90%). ¹H NMR (CDCl₃, ppm): 7.70 (d, J=10 Hz 1 H), 7.40-7.11 (m, 4 H), 6.90-6.86 (m, 2 H), 5.30-5.40 (m, 2 H-6 H), 2.52-2.82 (m, 4 H), 2.00-2.05 (m, 3 H), 1.63-1.59 (m, 3 H), 1.37-1.25 (m, 13 H), 0.97-0.86 (m, 4 H).LC-MS: n=6, m/z (M+NH₄)⁺, 442.2847; n=4, m/z (M+NH₄)⁺, 444.3008; n=2, m/z (M+NH₄⁺, 446.3157.

b. Synthesis of Phthalocyanine Mixture

2 g of a mixture of phthalonitrile (2.34 mmol) and 0.1 g of Zn(OAc)₂ (0.58 mmol) in 10 mL of dry 1-hexanol was heated to 100° C., then 1 mL of DBU was added. The mixture was stirred at 140-150° C. for 24 hours. Then the solvent was removed, the residue was purified on silica gel chromatography to get greenish solid compound 1 mixture. (0.4 g, yield: 38%). LC-MS: (M⁺ or M+H⁺) 1764.9571, 1766.9640, 1768.9806, 1769.9852, 1771.9945, 1774.0088, 1775.0180, 1777.0254.

### Inventive Example 4

Same procedure was conducted excepting for Dye 4 disclosed below was used instead of Dye 1.

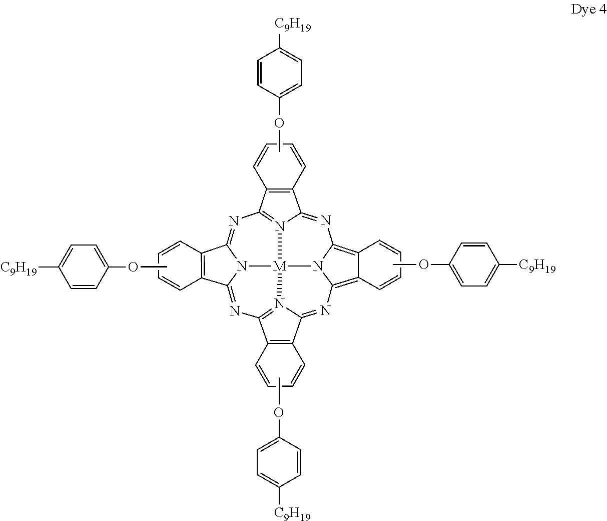

### Synthesis of Dye 4

a. Synthesis of Phthalonitrile

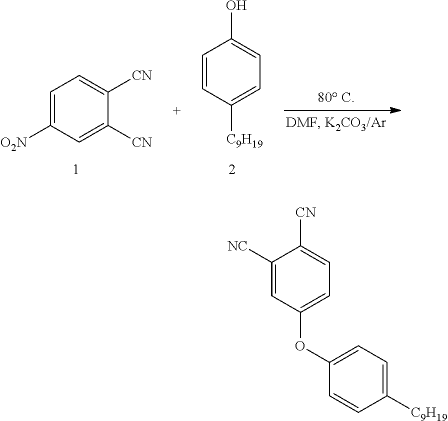

5 g of 4-nitrophthalonitrile (28.9 mmol) and 8.3 g of nonylphenol (37.8 mmol, supplied from Aladdin-reagent co., ltd.) were dissolved in 50 mL of dry DMF, and 5.9 g of anhydrous K₂CO₃ (43.1 mmol) was added in portions during 4 hours. The mixture was stirred at 80° C. for 10 hours under the nitrogen atmosphere.

Then the solvent was removed, and the residue was purified on silica gel chromatography to get oily liquid phthalonitrile(8.5 g, yield: 85%). LC-MS 364 m/z (M+NH₄)⁺.

b. Synthesis of Dye 4

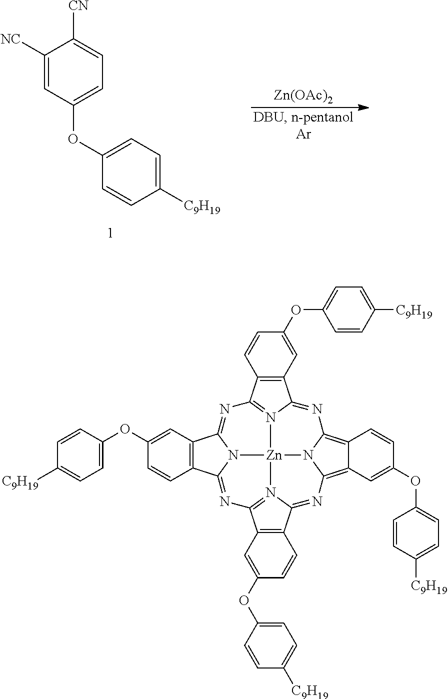

0.52 g of a mixture of phthalonitrilel (1.44 mmol) and 0.066 g of Zn(OAc)₂ (0.36 mmol) in 10 mL of dry 1-hexanol was heated to 100° C., then 0.5 mL of DBU was added. The mixture was stirred at 140-150° C. for 24 hours. Then the solvent was removed, the residue was purified on silica gel chromatography to get greenish solid compound 1. (0.21 g, yield: 40%). LC-MS 1449.7523 m/z (M+H)⁺.

### Comparative Example 1

Same procedure was conducted excepting for Dye 5 disclosed below (C.I. solvent blue 63, supplied from Yabang Co., Ltd) was used instead of Dye 1.

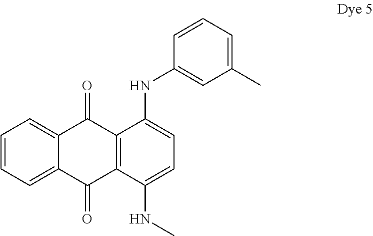 [SMILES: CNc1ccc(Nc2cccc(C)c2)c2c1C(=O)c1ccccc1C2=O]

### Comparative Example 2

Same procedure was conducted excepting for Dye 6 disclosed below (C.I. disperse red 343, supplied from Yabang Co., Ltd) was used instead of Dye 1.

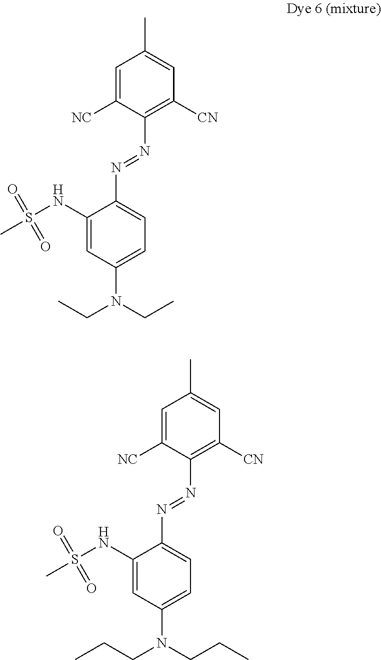 [SMILES: CCN(CC)c1ccc(/N=N/c2c(C#N)cc(C)cc2C#N)c(NS(C)(=O)=O)c1 ; CCCN(CCC)c1ccc(/N=N/c2c(C#N)cc(C)cc2C#N)c(NS(C)(=O)=O)c1]

### Comparative Example 3

Same procedure was conducted excepting for Dye 7 (supplied from Aldrich, 95% purity) disclosed below was used instead of Dye 1.

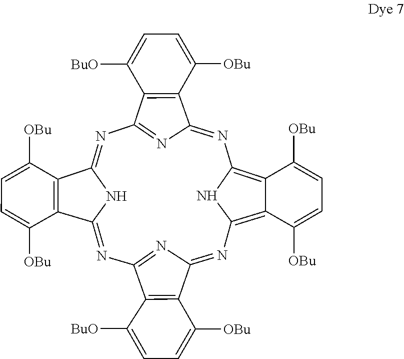

### Comparative Example4

Same procedure was conducted excepting for Dye 8 (supplied from Aldrich, 99% purity) disclosed below was used instead of Dye 1.

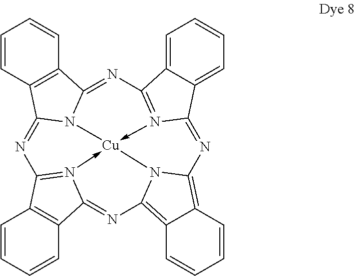

Referring to Table 1, it can be found that comparative Examples 1,2 and 3have a very poor thermal stability. And for comparative Example 4, it is insoluble in both cyclohexanone and PGMEA. The inventive examples 3 and 4 showed extremely high solubility both in cyclohexane and PGMEA. High thermal stability and fairly good solubility are both the advantages of the dyes of the present invention when it is used in a color filter.

TABLE 1

| | Inventive examples | | | | Comparative examples | | | |
|---|---|---|---|---|---|---|---|---|
| | 1 | 2 | 3 | 4 | 1 | 2 | 3 | 4 |
| Solubility in cyclohexanone | 4.5 | 1.7 | 25.3 | 20.0 | 3.0 | 4.0 | 9.0 | insoluble |
| at 25° C. (wt %) | | | | | | | | |
| Solubility in PGMEA at | 0.10 | 0.04 | 18 | 14 | 1.23 | 1.98 | 0.17 | insoluble |
| 25° C. (wt %) | | | | | | | | |
| Mass loss measured by TGA | 0.11 | 0.12 | 1.16 | 0.85 | 14.04 | 9.56 | 13.08 | 0.02 |
| at 230° C. for 1 hour (%) | | | | | | | | |
| Film thickness (micron) | 0.9 | 0.9 | 0.9-1.1 | 0.9-1.1 | 0.9 | 0.9 | 0.9-1.1 | — |
| Thermal stability of a film at | 1.6 | 0.9 | 3.1 | 1.9 | 18.4 | 13.3 | 21.5 | — |
| 230° C. (ΔE_{ab}) | | | | | | | | |
| Thermal stability of dyes in | — | — | 8.1 | 1.7 | — | — | — | — |
| PGMEA (ΔE_{ab} without a | | | | | | | | |
| resin) | | | | | | | | |

1. A compound for a color filter of a liquid crystal display, represented by the general formula (1) 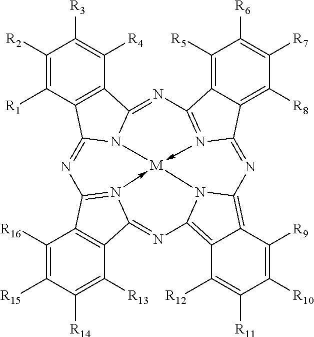
wherein R1 to R16 are independently selected from the group consisting of;
(A)hydrogen atom,
(B)straight-chain, branched or cyclic saturated or unsaturated hydrocarbon groups having 1 to 50 of carbon atoms,
(C)aryl groups substituted by at least one saturated or unsaturated hydrocarbon group having 1 to 50 of carbon atoms,
(D)aryloxy groups substituted by at least one saturated or unsaturated hydrocarbon group having 1 to 50 of carbon atoms and
(E)—O—R17, wherein R17 is selected from saturated or unsaturated hydrocarbon groups having 1 to 50 of carbon atoms;
whereas at least one of R1 to R4, at least one of R5 to R8, at least one of R9 to R12 and at least one of R13 to R16 are selected from the group consisting of (B), (C), (D) and (E);
wherein M is selected from Zn²⁺, Cu²⁺, Ni²⁺, Co²⁺, AlCl²⁺ or SiCl₂²⁺.

2. The compound of claim 1 wherein hydrocarbon groups of (B) to (E) are unsaturated.

3. The compound of claim 1 wherein at least one of R1 to R4, at least one of R5 to R8, at least one of R9 to R12 and at least one of R13 to R16 have 8 to 20 of carbon atoms.

4. The compound of claim 1 wherein two or more of R1 to R4, two or more of R5 to R8, two or more of R9 to R12 and two or more of R13 to R16 are selected from the group consisting of (B), (C), (D) and (E).

5. The compound of claim 1 wherein the formula (1) compound is selected from the formula (2.) 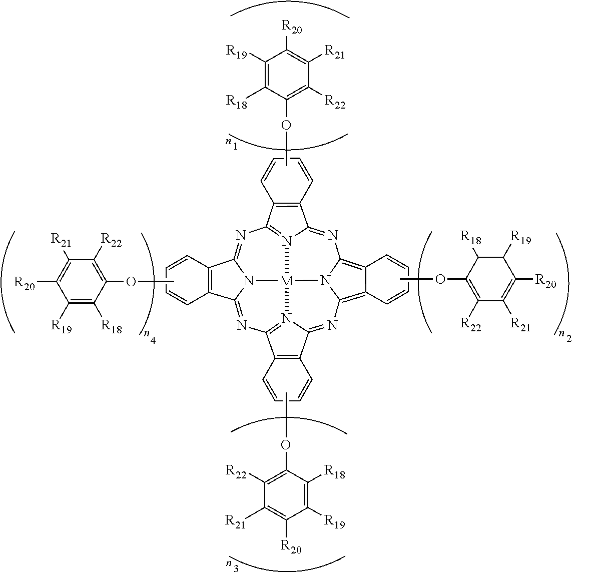
wherein R18 to R22 are independently selected from hydrogen atom, saturated or unsaturated hydrocarbon atoms having 1 to 50 of carbon atoms. At least one of R18 to R22 is saturated or unsaturated hydrocarbon atoms. n1, n2, n3 and n4 are integer of 1 to 4. M is selected from Zn²⁺, Cu²⁺, Ni²⁺, Co²⁺, AlCl²⁺ or SiCl₂²⁺.

6. A composition comprising an alkaline soluble resin and a compound as recited in claim 1.

7. The composition of claim 6 wherein the concentration of the compound represented by the general formula (1) is 1 to 50% by weight based on the total solid contents of the composition.

8. The composition of claim 6 wherein the alkaline soluble resin is acrylic resin.

9. An article having a polymer layer formed from the composition of claim 6.

10. The article of claim 9, wherein the thickness of the polymer layer is 0.1 to 4 micron.

11. A color filter comprising at least one compound as recited in claim 1.

12. The composition of claim 6 wherein hydrocarbon groups of (B) to (E) are unsaturated.

13. The composition of claim 6 wherein at least one of R1 to R4, at least one of R5 to R8, at least one of R9 to R12 and at least one of R13 to R16 have 8 to 20 of carbon atoms.

14. The composition of claim 6 wherein two or more of R1 to R4, two or more of R5 to R8, two or more of R9 to R12 and two or more of R13 to R16 are selected from the group consisting of (B), (C), (D) and (E).

15. The composition of claim 6 wherein the formula (1) compound is selected from the formula (2) 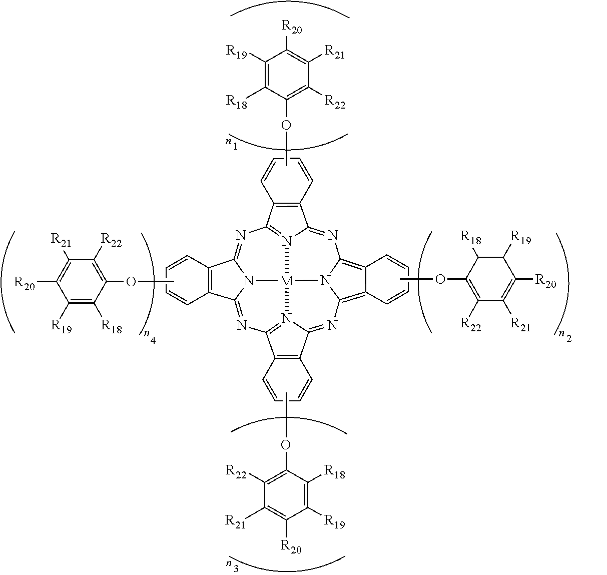
wherein R18 to R22 are independently selected from hydrogen atom, saturated or unsaturated hydrocarbon atoms having 1 to 50 of carbon atoms. At least one of R18 to R22 is saturated or unsaturated hydrocarbon atoms. n1, n2, n3 and n4 are integer of 1 to 4. M is selected from Zn²⁺, Cu²⁺, Co²⁺, AlCl²⁺ or SiCl₂²⁺.

16. The color filter of claim 11 wherein hydrocarbon groups of (B) to (E) are unsaturated. 1 7. (new) The color filter of claim 11 wherein at least one of R1 to R4, at least one of R5 to R8, at least one of R9 to R12 and at least one of R13 to R16 have 8 to 20 of carbon atoms.

18. The color filter of claim 11 wherein two or more of R1 to R4, two or more of R5 to R8, two or more of R9 to R12 and two or more of R13 to R16 are selected from the group consisting of (B), (C), (D) and (E).

19. The color filter of claim 11 wherein the formula (1) compound is selected from the formula (2) 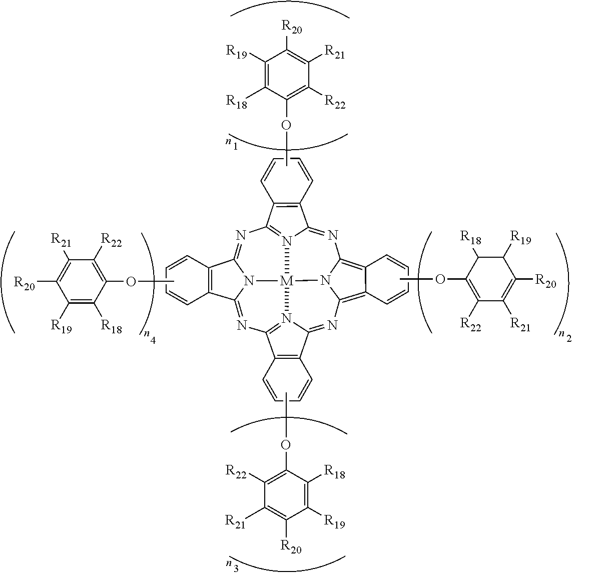
wherein R18 to R22 are independently selected from hydrogen atom, saturated or unsaturated hydrocarbon atoms having 1 to 50 of carbon atoms. At least one of R18 to R22 is saturated or unsaturated hydrocarbon atoms. n1, n2, n3 and n4 are integer of 1 to 4. M is selected from Zn²⁺, Cu²⁺, Co²⁺, AlCl²⁺ or SiCl₂²⁺.
